(19) United States
(12) Patent Application Publication
(10) Pub. No.: US 2016/0057392 A1
(43) Pub. Date: Feb. 25, 2016

(54) COMPUTING DEVICE FOR USE IN A VEHICLE

(71) Applicants: Aviram MEIDAN, Or-Yeuda (IL); Eyal STEINBERG, Herzliya (IL)

(72) Inventors: Aviram MEIDAN, Or-Yeuda (IL); Eyal STEINBERG, Herzliya (IL)

(73) Assignee: MICRONET LTD., Azor (IL)

(21) Appl. No.: 14/464,058

(22) Filed: Aug. 20, 2014

(51) Int. Cl. H04N 7/18; G06K 9/00; G06Q 10/06

(52) U.S. Cl. CPC H04N 7/181; G06Q 10/063114; G06K 9/00845

(57) ABSTRACT

A computing device for a vehicle comprising: a display screen; a central processing unit configured to run an operating system and at least one application operable to output an internal video signal adapted to be displayed on the display screen; a camera interface configured to receive a video input from one or more external cameras and to output corresponding external video signals for display on the display screen; a multiplexing unit configured for receiving the internal video signal and the one or more external video signals, the multiplexing unit comprising a display output coupled to the display screen and being configured for selectively forwarding one of the internal video signal and the one or more external video signals on the display output towards the display screen; and a controller unit configured for controlling the selective forwarding of the multiplexing unit based on controller input received by the controller unit.

### TECHNOLOGICAL FIELD

The present disclosure relates generally to the field of vehicle computing equipment. More particularly, the present disclosure relates to a computing device useful for fleet management and driver assistance.

### BACKGROUND

Operators of fleets of vehicles, including for example trucking and bus companies, are faced with the task of supervising the drivers of such vehicles. For example, the hours of service of the drivers have to be recorded in order to meet regulations, and the route actually used by the driver should be monitored to detect deviation from prescribed routes. On the other hand, drivers of vehicles are faced with the task of driving safely and efficiently to their destination. For example, drivers have to avoid excessive fatigue, collisions, infringing driving regulations, etc.

Computing devices have been developed to assist such drivers or supervisors in achieving their tasks. For example, systems have been developed to increase safety by offering technologies that alert the driver to potential problems, or to avoid collisions by implementing safeguards and taking over control of the vehicle. Other computing devices have been developed to increase the driver's comfort by, for example, automating lighting, providing adaptive cruise control, incorporating GPS navigation tools, or connecting to smartphones.

Computing devices have also been developed for providing the fleet supervisor with information useful for managing the driver. For example, the supervisor may be automatically provided with data indicative of the driver's behavior such as deviation from the prescribed route, driving hours, etc.

### GENERAL DESCRIPTION

The Applicant has found that it is possible to implement driving assistance and fleet management functionalities on the same computing device. Therefore, the present disclosure is directed to a computing device for a vehicle useful for assisting both a driver and a fleet operator. More particularly, the Applicant has found that a computing device generally used for fleet management can be used for displaying an external video stream provided for example by an external camera positioned outside of the vehicle, preferably at the rear of the vehicle.

The computing device according to the present disclosure therefore provides external video camera collaboration capability adapted to the challenges of on-board vehicle use. Generally, computing devices for fleet management or driving assistance comprise a central processing unit linked to a display screen and to communication and geolocating means. The central processing unit is adapted to run an operating system serving several applications which can be used to provide the driver or supervisor with dedicated information.

FIG. 1 illustrates a conventional technique for allowing management of external video capability on such a computing device. As explained above, a conventional computing device includes generally a display screen 140 and a central processing unit (CPU) 120 running an operating system—for example Android™—and one or more software applications. A conventional hardware solution for external video capability further includes a connector 120 for receiving a video stream from an external camera 110. Typically, the management of the video channel is performed through the CPU's operating system via a dedicated software application based on the operating system.

The Applicant has found that managing video in the conventional way causes latency in the display of the video stream and fails to achieve sustainability of the video display when the central processing unit crashes. In the context of on-board vehicle use, these drawbacks are critical for road safety and led the Applicant to develop an improved solution.

Therefore, the present disclosure provides a computing device for a vehicle comprising: a display screen; a central processing unit configured to run an operating system and at least one application, wherein the at least one application is operable to output an internal video signal adapted to be displayed on the display screen; a camera interface configured to receive a video input from one or more external cameras and to output one or more corresponding external video signals for display on the display screen; a multiplexing unit configured for receiving the internal video signal and the one or more external video signals, the multiplexing unit comprising a display output coupled to the display screen and being configured for selectively forwarding one of the internal video signal and the one or more external video signals on the display output towards the display screen; and a controller unit configured for controlling the selective forwarding of the multiplexing unit based on controller input received by the controller unit.

In some embodiments, the controller unit comprises an operating system-less controller.

In some embodiments, the multiplexing unit thereby enables the display screen to alternatively display one of the internal video signal and the external video signals.

In some embodiments, the camera interface is configured to receive an analog video input and to convert the analog video input into a digital external video signal.

In some embodiments, the multiplexing unit is further configured to convert the one or more output external video signals into a format adapted to be displayed on the display screen.

In some embodiments, the at least one application is a driving assistance application.

In some embodiments, the at least one application is a fleet management application.

In some embodiments, the computing device further comprises: an internal speaker; an audio interface configured to receive an audio input from at least one external microphone and to output an external audio signal; wherein the at least one application is further operable to output an internal audio signal adapted to be interpreted by the internal speaker; and the multiplexing unit is further configured for receiving the internal audio signal and the external audio signal, the multiplexing unit further comprising an audio output coupled to the internal speaker and being configured for selectively forwarding one of the internal audio signal and the external audio signal on the audio output towards the internal speaker.

In some embodiments, the multiplexing unit thereby enables the internal speaker to alternatively play the internal audio signal or the external audio signal and wherein an audio path thereby bypasses the central processing unit.

In some embodiments, the audio interface is further configured to amplify the received audio input.

In some embodiments, the at least one application manages another microphone.

In some embodiments, the computing device further comprises an additional speaker, the multiplexing unit comprises an additional audio output coupled to the additional speaker and the multiplexing unit is further configured for selectively forwarding one of the internal audio signal and the external audio signal on the additional audio output towards the additional speaker.

In some embodiments, the multiplexing unit comprises an audio module dedicated to multiplexing of audio signals and a video module dedicated to multiplexing of video signals.

In some embodiments, the controller unit is adapted to directly receive controller input from a CAN bus of the vehicle.

In some embodiments, the controller unit is configured to cause the multiplexing unit to display one of the external video signals when predefined vehicle conditions are detected based on the CAN bus input.

In some embodiments, the predefined conditions include at least one of: ignition of the vehicle, reverse driving, right turn, left turn.

In some embodiments, the controller unit is adapted to receive controller input from at least one of: one or more control switches positioned on a housing of the computing device, a power drop mechanism, a system reset mechanism and a power up key.

In some embodiments, at least one of the one or more external video signals is recorded.

In another aspect, the present disclosure provides vehicle equipment comprising a computing device as previously described and at least one external camera configured for being arranged on a vehicle.

In another aspect, the present disclosure provides a vehicle including vehicle equipment as previously described, the at least one external camera being arranged at the front of the vehicle, at the rear of the vehicle or at a side of the vehicle.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a functional diagram illustrating a conventional architecture for implementing external video capability on a computing device.

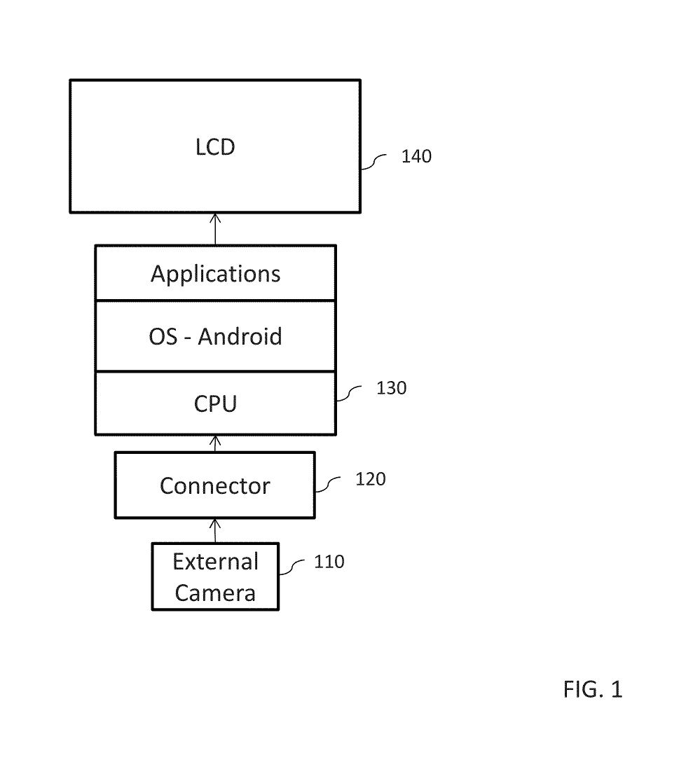

FIG. 2 illustrates a front perspective view of a computing device according to some embodiments of the present disclosure.

FIG. 3 is a functional diagram illustrating multiplexing of an application data flow and an external video data flow according to embodiments of the present disclosure.

FIG. 4 is a functional diagram illustrating multiplexing of an application data flow and an external audio data flow according to some embodiments of the present disclosure.

### DETAILED DESCRIPTION OF EMBODIMENTS

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrase “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination. In particular, it is understood that the present disclosure encompasses a any combination of the features recited in the appended claims,

Unless specifically stated otherwise, as apparent from the following discussions, it is appreciated that throughout the specification discussions utilizing terms such as “generating”, “determining”, “providing”, “receiving”, “using”, “computing”, “transmitting”, “performing”, or the like, may refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

In the present disclosure, “internal” and its derivatives is generally used to indicate that an element is comprised or originates within the computing device whereas “external” is generally used to qualify an element as comprised or originating from outside the computing device. For example, the term “external camera” is used to refer to a camera collaborating with the computing device while not integrated within the computing device. Further, the term external video signal is used to refer to a signal originating from the external camera. In contradistinction, the term internal video signal is used to refer to a video signal originating from the computing device itself. For example, the internal video signal may result from an internal camera (i.e. a camera housed in the computing device and controlled by the central processing unit of the computing device) or from an application software running on the computing device.

The term “camera” is generally used in the present disclosure to refer to an imaging unit capable of acquiring images of a scene. The camera may be an analog camera requiring analog to digital conversion for the video stream to be digitally processed. In some embodiments, the external camera may, alternatively, be a digital camera.

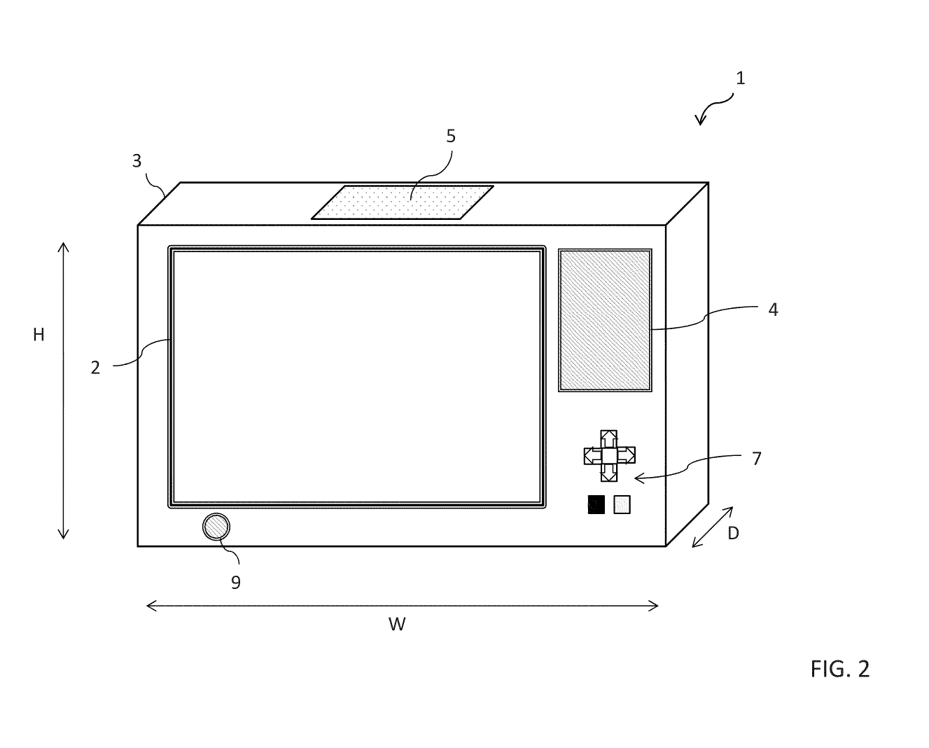

FIG. 2 illustrates a front perspective view of a computing device 1 according to embodiments of the present disclosure. The computing device 1 may be configured for being mounted in a docking station (not shown), the docking station being arranged in a vehicle. The computing device 1 may be fixed in the docking station or removably mounted in the docking station. The docking station may be positioned in the vehicle so that the driver can easily see and touch the computing device 1. The computing device 1 may be assembled in a housing 3. The computing device 1 may comprise a display screen 2 and an external connector 5 including a camera connector for connecting one or more external cameras. Optionally, as explained herein, the computing device 1 may also include an internal speaker 4, control switches (keys) 7 and an internal microphone 9.

The housing 3 may generally have a tablet shape. The housing 3 may generally have small dimensions, a width W being typically less than 30 cm, a height H typically less than 25 cm, and a depth D typically less than 30 mm. Preferably, the width W is less than 25 cm, the height H is less than 20 cm and the depth D is less than 25 mm. The housing 3 may be adapted to reside in a variety of locations and may be well adapted to be brought out of the vehicle, for example during on-site inspection or for preventing theft. The overall weight of the computing device may be less than 0.5 kg, preferably less than 0.2 kg. The computing device 1 may therefore be used as a portable autonomous device, provided with an embedded rechargeable battery, which can be recharged through a wired connection, available for example when the computing device 1 is locked in the docking station.

The display screen 2 may be capable of displaying images in black and white, gray scale or full colors. Further, the display screen may be a touch screen capable of receiving user input. This may enable the user to perform various operations via touch interactions. In some embodiments, the touch screen 2 may be a resistive interface rather than capacitance-based to facilitate the use of a stylus type input device and to enable operators to use their fingers while wearing gloves as might be encountered in an industrial environment.

Other methods of interactions can be additionally used, such as speech recognition and actuation of one or several physical control switches 7 (also referred to herein as keys or push buttons). The one or more control switches 7 may include a power on switch and one or more additional keys for use in interacting with the computing device 1. The one or more control switches 7 may be positioned on the housing 3 close to the display screen 2. The control switches 7 may be identified by a sign formed on a surface of said control switches 7. For example, a specific shape or color may enable to easily identify the control switches 7.

In some embodiments, the computing device 1 may further include geolocation means. For example, the computing device 1 may be provided with GPS, GNSS, GLO-NASS, Galileo, IRNSS and/or Beidou-2 capabilities to enable locating the vehicle in which the computing device 1 is mounted. Additionally, the computing device may also include memory storing for among others, cartographic data for use in a navigation application. In some embodiments, the geolocation means may be included in a separate geolocation unit logically coupled to the computing device 1.

In some embodiments, the computing device 1 may comprise wireless communication means. The communication means may comprise short range wireless communication means enabling for example a Wi-Fi or Bluetooth connection and/or long range wireless communication means enabling for example a cellular telecommunication connection, for example a GSM, 3G or 4G thereby providing a connection to the Internet. The communication means may enable the computing device 1 to implement fleet management applications, messaging applications, etc.

The central processing unit (not shown on FIG. 2) may be configured to run an operating system and at least one application software (generally referred to hereinafter as “application”). The at least one application may be operable to output an internal video signal adapted to be displayed on the display screen 2. It is understood that the term video signal hereby generally encompasses graphical signals adapted to be displayed on the screen. As explained below, the computing device may also include a multiplexing unit and a controller unit for managing display on the display screen (not shown on FIG. 2). The at least one application software may be configured to operate through the operating system i.e. the operating system may act as an interface between the application software and the physical resources of the computing device 1. The operating system may be Android or the like. The computing device 1 may be basically an open computer platform designed as an after-market product for vehicles i.e. not embedded in the vehicle's intrinsic equipment. The central processing unit may be configured for simultaneously run an operating system and the at least one application managed through the operating system.

The at least one application may include:
a navigation application intended to provide guidance from a starting point to a destination point with reference to a cartographic map. The navigation application may provide maneuvering indications to the driver during the course of driving.
a fleet management application intended to provide the fleet supervisor with information on the vehicle. For example the fleet management application may provide the fleet supervisor with reporting data such as vehicle diagnostic data, driver's logs, GPS data, message data, photos, etc.
a wireless/mobile phone application, intended to allow the user to place and receive phone calls, possibly via the device itself or via a Bluetooth associated mobile phone,
a most frequent settings application, intended to allow the user to adjust some most frequently used settings of the device such as screen brightness, etc.,
a dangerous/risk areas signaling application intended to inform the user about the hazard or risk areas along the route, not excluding speed control areas, this application being preferably supported by a displayed map,
a traffic information application intended to inform the user about any traffic congestion area, roadworks, and the like, this application being preferably supported by a displayed map, the traffic information data being also used by the navigation application to provide optimal guidance,
a music player application, intended to allow the user to play music, for example digital MP3 music from the memory of the device or from the memory of a Bluetooth associated mobile phone,
an instant messaging application, intended to allow the user to send and receive instant messages like Facebook®, Twitter®, MSN®, or the like,
an electronic mail application intended to allow the user to send and receive electronic mails,
an Internet browser application, intended to allow the user to access the Internet network and perform searches,
a weather forecast application intended to inform the user about weather forecasts, possibly in relation to the current position of the device,
a yellow pages/directory application, intended to allow the user to search for professional services, possibly in relation to the current position of the device,
a fuel stations application, intended to allow the user to search for fuel stations and current fuel prices, possibly in relation to the current position and in accordance with the planned route,
a parking lot application, intended to allow the user to search for available parking spots, in relation to the current position and in accordance with the planned route,
a configuration application intended to allow the user to adjust all parameters of the device (not only most frequent settings),
a video player, allowing to play videos or show pictures, an eco-driving application, intended to inform the user about how economical his/her driving is, and to provide hints on how to decrease fuel consumption.

This list is not limiting. In some embodiments, several applications—for example 10 to 15 applications—are run simultaneously on the computing device 1. It is understood that the internal signal may include graphical output from one or more of the above applications. Some of the applications may permanently be hosted in the computing device while others can be loaded from the Internet via the communication means upon instructions of the user, for example from an application store.

The computing device 1 may comprise a camera interface configured for receiving a video input from one or more external cameras and to output corresponding one or more external video signals for further display on the display screen. The camera interface may include a camera connector to enable connection between the one or more external cameras and the computing device 1. The external connector 5 may include the camera connector. The camera connection may be a wire connection or a wireless connection. The one or more external cameras may be arranged on the vehicle so as to provide at least one of:
a rear view, for example for assisting the driver in reverse driving,
a front view, for example for enabling recording of the road ahead of the driver,
a left side view or a right side view, for example for displaying blind spots when turning.

In other words, the external cameras may include at least one of: a rear camera providing a rear view, a front camera providing a front view, a right or left side camera providing a left or right side view. In some embodiments, the external camera(s) may be mounted on movable structures enabling pivoting the external cameras. In these embodiments, the computing device 1 may also be configured for managing the orientation of the one or more cameras, for example based on image analysis, cartographic data, vehicle situation, etc.

In some embodiments, the external connector 5 may further be configured for providing a connection to the CAN (Control Area Network) bus of the vehicle i.e. to include a CAN bus connector. In other words, the controller unit may be adapted to directly receive controller input from a CAN bus of the vehicle (also referred to as CAN bus messages). The controller unit may comprise a CAN bus interface configured for interpreting the CAN bus communication protocol. This may enable the controller unit to control the multiplexer based on received CAN bus controller input. For example, a CAN bus message received by the controller unit may include data indicative that a turn signal lamp on a side of the vehicle is activated and the controller unit may trigger the display of the corresponding side external camera. It is to be noted that the present disclosure provides real time display because the controller unit may enable hardware level actions instead of conventional application level actions. Further, the present disclosure provides for a system with no operating system or main central processing unit dependency. Additionally, it is noted that the application may keep running while the external camera signal is displayed so that service to the users may not be interrupted. The CAN bus may provide the computing device 1 with information on the vehicle's condition. This may enable to trigger the display of the external video signal based on predefined conditions such as a driving event. For example, display of the external video signal from one of the side cameras may be triggered based on a right/left turn driving event or based on actuation of a right/left turn signal lamp of the vehicle. Similarly, display of the external video signal from the rear external camera may be triggered based on a reverse driving event. In some embodiments, triggering of the display may also be carried out manually by using the one or more control switches 7. The external connector 5 may also be configured for providing connection between the computing device 1 and at least one of: various I/O from the vehicle such as reverse switch indication which, when received by the controller unit, may trigger rear camera display, the internal microphone 9, an external speaker which may be arranged in the driver's cabin, an ignition switch of the vehicle, car battery power indication, an external microphone which may be placed outside at the rear of the vehicle for providing instructions to the driver while reverse driving, etc. In some embodiments, the external connector 5 may be composed of several connectors each dedicated to one or more of the previously described connections. It is noted that certain vehicle conditions may be detected both through the CAN bus connection and through a direct I/O connection. For example, as explained, actuation of a turn signal lamp may be detected through the CAN bus and also through direct connection of the turn lamp signals to the controller unit via the external connector. This may enable a redundancy in the system.

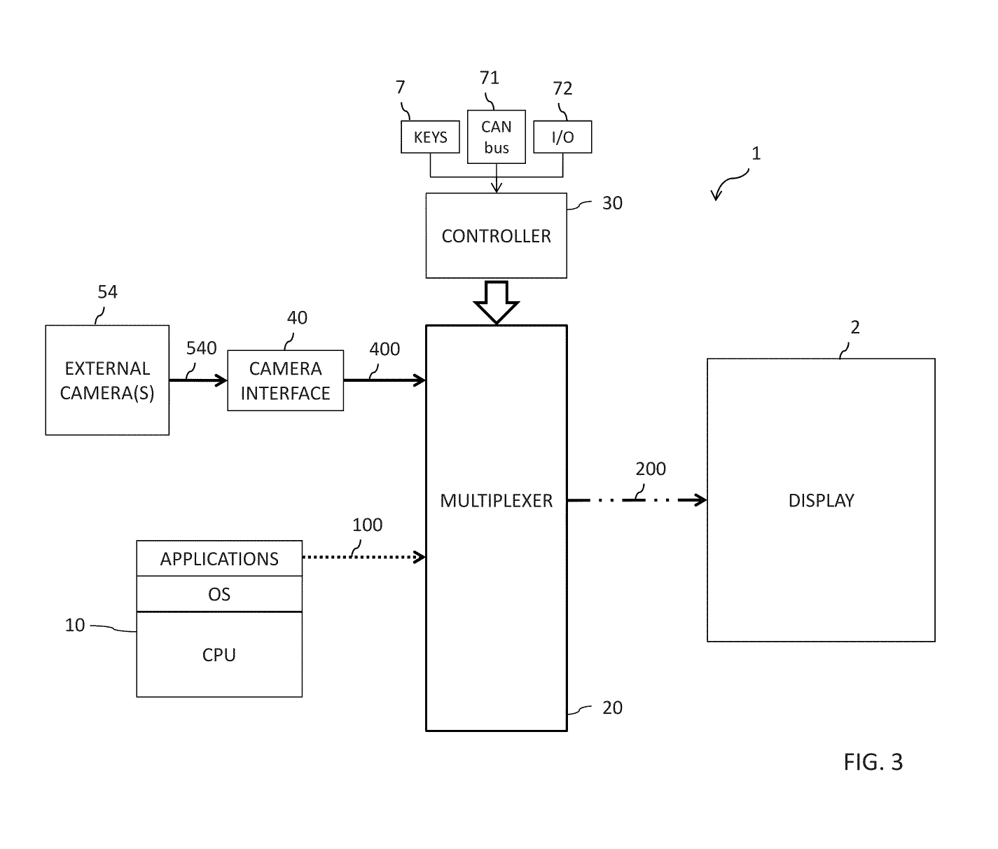

FIG. 3 is a functional diagram detailing some elements of the computing device 1 according to some embodiments of the present disclosure. For the sake of conciseness, description of the elements which have already been described with reference to the front perspective view of FIG. 2 is not repeated.

The computing device 1 may further comprise a multiplexer 20 configured for receiving an internal video signal 100 output from the central processing unit 10 and an external video signal 400 output by the camera interface 40. The multiplexer 20 may be coupled to the camera interface 40 and to the central processing unit 10. The camera interface 40 may additionally be configured as an analog to digital converter so as to be capable of converting the one or more video input 540 from the one or more external cameras 54 into one or more corresponding external video signals 400 in a format capable of being received by the multiplexer 20. The internal video signal 100 may be output by the at least one application software running on the CPU 10. As explained previously, the internal video signal may comprise a graphical signal output for example by the navigation application and/or a video signal output for example by the video player application.

The multiplexer 20 may further be configured for selectively forwarding one of the internal and external video signals 100, 400 on a display output 200 (output line) of the multiplexer 20 towards the display screen 2. The multiplexer 20 may act as a switch. The display output 200 of the multiplexer 20 may be coupled to the display screen 2. In some embodiments, when one of the one or more external video signals is forwarded, the multiplexer 20 may further be configured to further convert said external video signal to a format capable of being displayed on the display screen 2. The multiplexer 20 may be controlled by a controller unit 30 based on controller input received by said controller unit 30. The multiplexer 20 may be implemented as a Complex Programmable Logic Device (CPLD). The present disclosure thereby provides an architecture which enables the external camera(s) to bypass the operating system. Indeed, an external video path formed by the external camera 54, the camera interface 40, the multiplexer 20 and the display screen 2 may be separated from the central processing unit 10 running the operating system. This may advantageously decreases the load on the central processing unit 10. Further, this may also enable the external video signal to be displayed substantially instantaneously. In some embodiments, the external video signal may additionally be recorded and/or provided to the CPU for further video analyzing in order to monitor the driver's behavior, for example to detect dizziness.

The controller unit 30 may be configured for determining which one of the internal video signal and the external video signals to display on the display screen 2 and to operate the multiplexer 20 accordingly. The controller unit 30 may be an operating system-less controller. The controller unit 30 may be a microcontroller. The controller unit 30 may be a coprocessor. The controller unit 30 may be configured for sequential processing and/or for processing a single task at a time. This may enable to limit the crash and time out threats. The controller unit 30 may be configured to operate the multiplexer 20—selectively forward one of the video signal input into the multiplexer 20 i.e. either the internal video signal or one of the external video signal—using controller input received by the controller unit 30. This may enable to automatically forward one of the internal video signal and external video signals to the display screen based on predefined events detected by receiving the controller input. For example, the controller unit 30 may be implemented on STM32F1 series from STMicroelectronics or on Kinetis series from Freescale.

For example, the controller unit 30 may be configured to be connected to a CAN bus 71 of the vehicle so that the CAN bus may provide controller input to the controller unit 30. The connection to the CAN bus of the vehicle may be physically performed through the external connector 5. This may enable to trigger display of the external video signal based on predefined conditions such as a driving event. For example, display of the external video signal from one of the side cameras may be triggered based on a right/left turn driving event or based on actuation of the right/left turn signal lamp. Similarly, display of the external video signal from the rear external camera may be triggered based on a reverse driving event. This may also enable to detect an emergency state of the vehicle and to consequently display one of the external video signals. Additionally, display of the external video signal from one of the side external camera or from the rear external camera may be triggered based respectively on a side door opening event or on a trunk (rear) door opening event. Also, display of the external video signal from the front external camera may be triggered based on an airbag actuation event or on other accident detection event such as accelerometer mechanism. Other I/O 72 may also be connected to the controller unit through the external connector 5 and also provide controller input received by the controller unit 30. For example, as explained above, the turn signal lamps may be directly connected to the controller unit 30 through the external connector and may trigger side external camera display upon actuation. Furthermore, the control switches 7 may provide controller input to the controller unit 30. Indeed, actuation of the control switches 7 may also be interpreted by the controller unit 30 as a predefined event triggering display of one of the internal or external video signals.

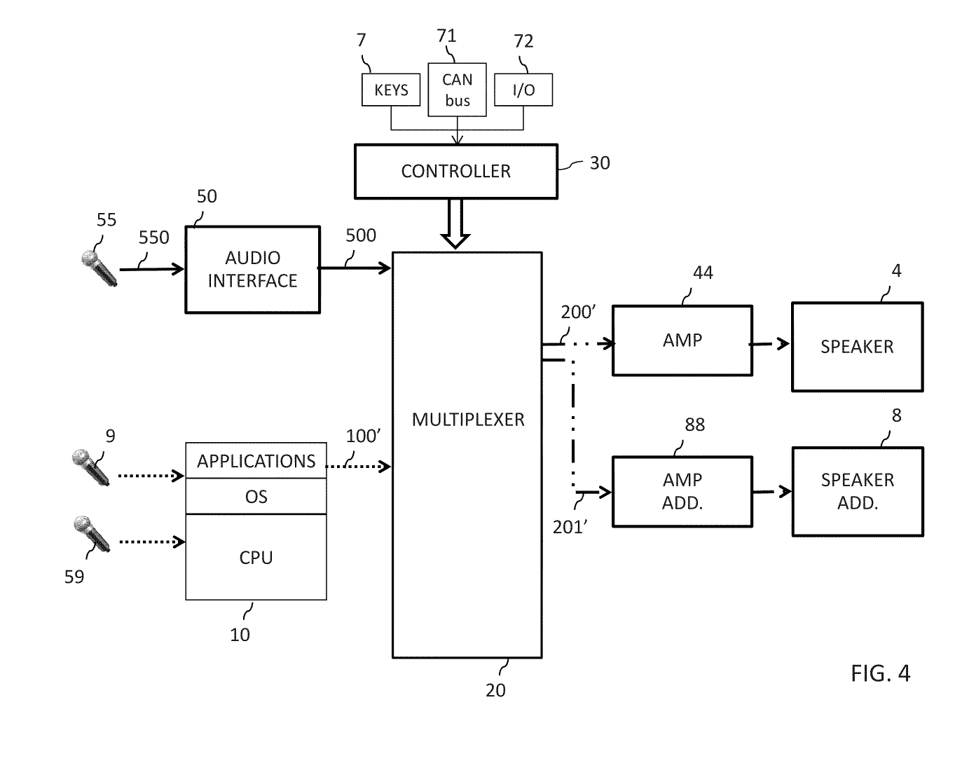

FIG. 4 illustrates elements of the computing device according to some embodiments of the present disclosure. In some embodiments, the video switching previously described with reference to FIG. 3 may be provided with comparable audio switching. More particularly, the computing device previously described may also comprise an internal speaker 4, an audio interface 50 configured to receive an audio input 550 from at least one external microphone 55 and to output an external audio signal 500. Further, the at least one application may further be operable to output an internal audio signal 100′ adapted to be interpreted by the internal speaker 4 to produce sound. The at least one application may for example manage the internal microphone 9 and/or an additional external microphone 59. The internal microphone 9 and/or the additional external microphone 59 may be directly managed through the operating system of the central processing unit 10 in contradistinction to the external microphone 55 managed through the separated audio path presently described. The multiplexer 20 may further be configured for receiving the internal audio signal 100′ and the external audio signal 500. The multiplexer 20 may be coupled to the audio interface 50 and to the central processing unit 10. The multiplexer 20 may comprise an audio output 200′ coupled to the internal speaker 4 and be configured to selectively forward one of the internal audio signal 100′ and the external audio signal 500 on the audio output 200′ towards the internal speaker 4. This may enable an external audio path (from the external microphone 55 to the speaker 4) to be separated from the central processing unit 10 thereby decreasing latency in playing the external audio signal on the internal speaker 4. Optionally, the computing device may collaborate with (or include) an additional speaker 8 and the multiplexer 20 may further comprise an additional audio output 201′ coupled with the additional speaker 8. The multiplexer 20 may further be configured for selectively forwarding one of the internal audio signal 100′ and the external audio signal 500 on the additional audio output 201′ towards the additional speaker 8. For example, the audio signal which is not forwarded to the internal speaker 4 may be forwarded to the additional speaker 8. Optionally, the audio output 200′ may be coupled to an amplifier 44 which is coupled to the speaker 4 and the additional audio output 201′ may be coupled to an additional amplifier 88 coupled to the additional speaker 8. In some embodiments, the audio switching and the video switching may be implemented on two separate multiplexers.

As in the video switching described in FIG. 3, the controller unit 30 may determine which of the internal or external audio signals 100′, 500 is to be forwarded to the internal speaker 4 and optionally which of the internal or external audio signals 100′, 500 is to be forwarded to the additional speaker 8. The selective forwarding may be based on received controller input from any one of: the CAN bus, the control switches or various I/O provided to the controller unit 30. In particular, these controller input enable to automatically detect predefined events which for example include: reverse driving or emergency situations. Furthermore, the controller unit 30 may also be configured for controlling the gain of an amplifier of the audio interface 50.

The present disclosure provides thereby for a video and/or audio channel bypassing the central processing unit and operating system circuit and providing direct connection to either a display means and/or a speaker. This notably provides a real time response upon command.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A computing device for a vehicle comprising:
(a) a display screen;
(b) a central processing unit configured to run an operating system and at least one application, wherein the at least one application is operable to output an internal video signal adapted to be displayed on the display screen;
(c) a camera interface configured to receive a video input from one or more external cameras and to output one or more corresponding external video signals for display on the display screen;
(d) a multiplexing unit configured for receiving the internal video signal and the one or more external video signals, the multiplexing unit comprising a display output coupled to the display screen and being configured for selectively forwarding one of the internal video signal and the one or more external video signals on the display output towards the display screen; and
(e) a controller unit configured for controlling the selective forwarding of the multiplexing unit based on controller input received by the controller unit.

2. The computing device according to claim 1, wherein the controller unit comprises an operating system-less controller.

3. The computing device according to claim 1, wherein the multiplexing unit thereby enables the display screen to alternatively display one of the internal video signal and the external video signals.

4. The computing device according to claim 1, wherein the camera interface is configured to receive an analog video input and to convert the analog video input into a digital external video signal.

5. The computing device according to claim 1, wherein the multiplexing unit is further configured to convert the one or more output external video signals into a format adapted to be displayed on the display screen.

6. The computing device according to claim 1, wherein the at least one application is a driving assistance application.

7. The computing device according to claim 1, wherein the at least one application is a fleet management application.

8. The computing device according to claim 1, further comprising:
(a) an internal speaker;
(b) an audio interface configured to receive an audio input from at least one external microphone and to output an external audio signal,
wherein:
the at least one application is further operable to output an internal audio signal adapted to be interpreted by the internal speaker; and
the multiplexing unit is further configured for receiving the internal audio signal and the external audio signal, the multiplexing unit further comprising an audio output coupled to the internal speaker and being configured for selectively forwarding one of the internal audio signal and the external audio signal on the audio output towards the internal speaker.

9. The computing device according to claim 8, wherein the multiplexing unit thereby enables the internal speaker to alternatively play the internal audio signal or the external audio signal and wherein an audio path thereby bypasses the central processing unit

10. The computing device according to claim 8, wherein the audio interface is further configured to amplify the received audio input.

11. The computing device according to claim 8, wherein the at least one application manages another microphone.

12. The computing device according to claim 8, further comprising an additional speaker, wherein the multiplexing unit comprises an additional audio output coupled to the additional speaker and the multiplexing unit is further configured for selectively forwarding one of the internal audio signal and the external audio signal on the additional audio output towards the additional speaker.

13. The computing device according to claim 8, wherein the multiplexing unit comprises an audio module dedicated to multiplexing of audio signals and a video module dedicated to multiplexing of video signals.

14. The computing device according to claim 1, wherein the controller unit is adapted to directly receive controller input from a CAN bus of the vehicle.

15. The computing device according to claim 14, wherein the controller unit is configured to cause the multiplexing unit to display one of the external video signals when predefined vehicle conditions are detected based on the CAN bus input.

16. The computing device according to claim 15, wherein the predefined conditions include at least one of: ignition of the vehicle, reverse driving, right turn, left turn.

17. The computing device according to claim 1, wherein the controller unit is adapted to receive controller input from at least one of: one or more control switches positioned on a housing of the computing device, a power drop mechanism, a system reset mechanism and a power up key.

18. The computing device according to claim 1, wherein at least one of the one or more external video signals is recorded.

19. Vehicle equipment comprising:
(a) a computing device including:
i) a display screen;
ii) a central processing unit configured to run an operating system and at least one application, wherein the at least one application is operable to output an internal video signal adapted to be displayed on the display screen;
iii) a camera interface configured to receive a video input from one or more external cameras and to output one or more corresponding external video signals for display on the display screen;
iv) a multiplexing unit configured for receiving the internal video signal and the one or more external video signals, the multiplexing unit comprising a display output coupled to the display screen and being configured for selectively forwarding one of the internal video signal and the one or more external video signals on the display output towards the display screen; and
v) a controller unit configured for controlling the selective forwarding of the multiplexing unit based on controller input received by the controller unit; and
(b) at least one external camera configured for being arranged on a vehicle.

20. A vehicle including vehicle equipment comprising:
(a) a computing device including:
i) a display screen;
ii) a central processing unit configured to run an operating system and at least one application, wherein the at least one application is operable to output an internal video signal adapted to be displayed on the display screen;
iii) a camera interface configured to receive a video input from one or more external cameras and to output one or more corresponding external video signals for display on the display screen;
iv) a multiplexing unit configured for receiving the internal video signal and the one or more external video signals, the multiplexing unit comprising a display output coupled to the display screen and being configured for selectively forwarding one of the internal video signal and the one or more external video signals on the display output towards the display screen; and
v) a controller unit configured for controlling the selective forwarding of the multiplexing unit based on controller input received by the controller unit; and
(b) at least one external camera configured for being arranged on a vehicle; wherein the at least one external camera is arranged at the front of the vehicle, at the rear of the vehicle or at a side of the vehicle.
